(19) United States
(12) Patent Application Publication
(10) Pub. No.: US 2020/0110819 A1
(43) Pub. Date: Apr. 9, 2020

(54) LOW COST FAST RECOVERY INDEX IN STORAGE CLASS MEMORY

(71) Applicant: International Business Machines Corporation, Armonk, NY (US)

(72) Inventors: Revital Erez, Tel Aviv (IL); Michael Factor, Haifa (IL); Moshik Hershcovitch, Tel Aviv (IL); Ronen I. Kat, Kokav-Yair (IL); Elliot K. Kolodner, Haifa (IL); Joel K. Nider, Zichron Yaakov (IL)

(21) Appl. No.: 16/153,891

(22) Filed: Oct. 8, 2018

(51) Int. Cl. G06F 17/30; G06F 11/07

(52) U.S. Cl. CPC G06F 17/30336; G06F 11/0751; G06F 17/30289

(57) ABSTRACT

A system and method for recovering a database and restoring an index following a failure of the database is disclosed. The method receives a change to a record in the database. The change is stored in a persistent data store, the persistent data store is divided into a plurality of segments. The volatile index is updated in volatile memory with a pointer to the record in the persistent data store. A shadow index is generated in the persistent data store, where the shadow index is a persistent copy of the volatile index and is not updated at the same time as the volatile index. The shadow thread is executed on the plurality of records where the shadow thread scans each record in the persistent storage device to populate and update the shadow index, wherein the shadow thread operates as a background operation on the persistent data store.

### BACKGROUND

The present disclosure relates to recovery of a database, more specifically to restoring a database index following a failure.

A durable database is a database that can recover its data after a crash to a certain point in time. A database consists of a record part (data) and an index part. In a durable database, there are two data layers: the volatile layer where the data resides in memory and vanishes after a crash, and the persistent layer that allows the database to be durable and survive a crash. However, if the index data structure is stored in the storage class memory, it can become a bottleneck when performing commands that affects the index, for example, an update, insert, or delete of a record.

### SUMMARY

Embodiments of the present disclosure are directed to a system and method for recovering a database and restoring an index following a failure of the database. The method receives a change to a record in the database. The change is stored in a persistent data store, the persistent data store is divided into a plurality of segments. The volatile index is updated in volatile memory with a pointer to the record in the persistent data store. A shadow index is generated in the persistent data store, where the shadow index is a persistent copy of the volatile index and is not updated at the same time as the volatile index. The shadow thread is executed on the plurality of records where the shadow thread scans each record in the persistent storage device to populate and update the shadow index, wherein the shadow thread operates as a background operation on the persistent data store.

Embodiments of the present disclosure are also directed to a computer program product including instructions for recovering a database and restoring an index following a failure of the database. The instructions include instructions to receive a change to a record in the database. The change is stored in a persistent data store that is divided into a plurality of segments. The instructions update the volatile index in volatile memory with a pointer to the record in the persistent data store. A shadow index is generated in the persistent data store, where the shadow index is a persistent copy of the volatile index and is not updated at the same time as the volatile index. The instructions execute the shadow thread on the plurality of records where the shadow thread scans each record in the persistent storage device to populate and update the shadow index, wherein the shadow thread operates as a background operation on the persistent data store. When the shadow thread encounters a segment that includes at least one record that has not been committed, the instructions skip adding the at least one record that has not been committed to the shadow index; and add a pointer to the at least one record that has not been committed to a waitlist. The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating system that uses a two-copy index for in-memory persistent data store, according to embodiments.

FIG. 2 is a diagrammatic illustration illustrating a relationship between segments in the persistent memory according to embodiments.

FIG. 3 is a diagrammatic illustration illustrating a relationship between segments in the persistent data store when documents are being processed by the shadow thread according to embodiments.

FIG. 4 is a flow diagram illustrating a process for updating the shadow index by the shadow thread according to embodiments.

FIG. 5 is a flow diagram illustrating a process for recovering the database according to embodiments.

FIG. 6 is a block diagram illustrating a computing system according to one embodiment.

FIG. 7 is a diagrammatic representation of an illustrative cloud computing environment.

FIG. 8 illustrates a set of functional abstraction layers provided by cloud computing environment according to one illustrative embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relates to recovery of a database, more specifically to restoring a database index following a crash or other failure. While the present disclosure is not necessarily limited to such applications, various aspects of the disclosure may be appreciated through a discussion of various examples using this context.

Write Ahead Log (WAL) also referred as journaling is a primary method to ensure durability in databases. In this method, the database is stored in a file on disk and a copy of the changed records are written into a buffer pool in the volatile memory. When a record is updated, the update occurs in volatile memory, and the record is pinned in volatile memory until the record describing the change has been written to the log (as a log record) and is on persistent storage. In the recovery process upon a power loss, the journal will be rolled forward starting from the beginning such that all the commands in the journal will be inserted to the database by their order of entry. To avoid the need to replay all of the changes from the start of the log, a checkpoint mechanism is used. It ensures that all the dirty pages in the volatile memory will be synchronized to the persistent memory from time to time, so that the log can be emptied.

The drawback of WAL is that every record must be written multiple times to the persistent memory, once in the journal phase, and once in the checkpoint phase. This is in addition to the write to the DRAM. This is referred to as write amplification and can result in increased latency as well as increased wear on the physical device, and increased power consumption.

With SCM, a possible solution to achieve durability and avoid multiple writes is to use only the SCM and avoid volatile memory altogether. However, the drawback of this approach is performance loss since the access time to the SCM is assumed to be higher than access time to volatile memory. Furthermore, ensuring consistency is expensive as it requires executing special instructions to avoid data loss due to incomplete writes to the persistent memory when faced with a power failure. For example, in the x86 platform the ‘clflush’ and ‘mfence’ instructions are used for this purpose. ‘clflush’ invalidates the cache line that contains a given address, and ‘mfence’ guarantees that all previously issued memory reads and writes become globally visible before any reads or writes that follow the ‘mfence’ instruction. Both of these instructions can be quite costly and take hundreds or thousands of machine cycles to complete.

There are previous attempts that tried storing database indexes on the SCM to minimize this cost. One approach addressed this issue by using unsorted leaf index nodes to minimize the movements of the index entries and atomic writes to reduce the usage of flush instruction. The drawback of this approach was that it still needs to maintain the indexes on the SCM on the critical path. Other approaches tried to minimize the overhead by using a hybrid method: only the leaf nodes of the index were consistent in the persistent memory while inner nodes were placed on the volatile memory or placed on the persistent memory but were not consistent. The drawback these approaches was the need to rebuild the index after recovery.

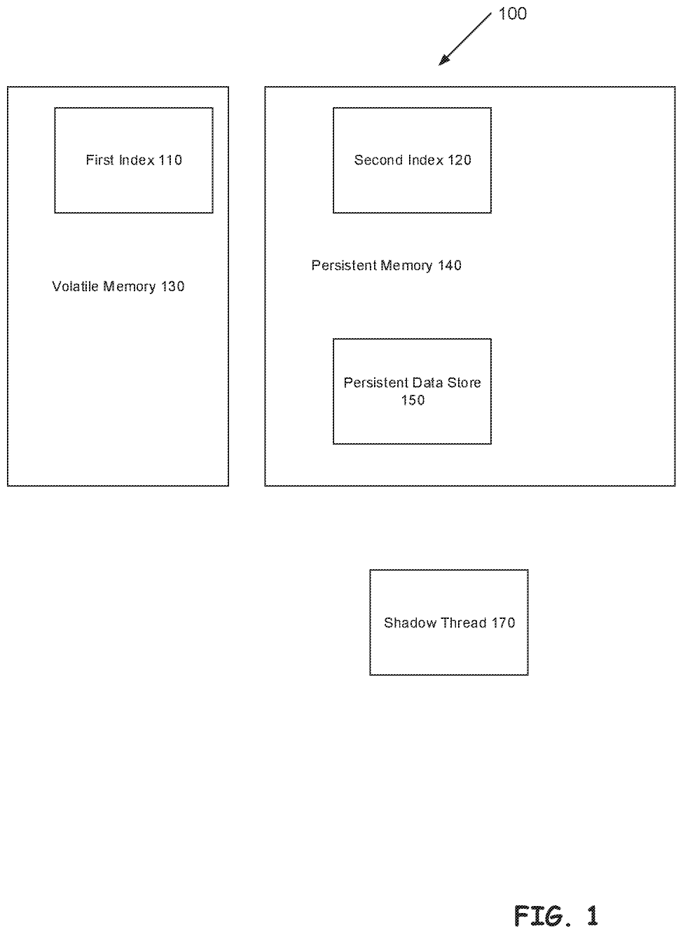

FIG. 1 is a block diagram illustrating system that uses a two-copy index for in-memory persistent data store, according to embodiments. System 100 includes a first index 110, and a second index 120. The first index 110 is a volatile copy and is stored in a volatile memory 130. In some embodiments, the volatile memory 130 is dynamic random access memory (DRAM). However, any volatile memory can be used. The second index 120 is a persistent copy as a shadow index stored in a non-volatile memory 140. In some embodiments the non-volatile memory 140 is Flashed based DRAM. However, any non-volatile memory type that is a storage class memory can be used for the memory 140 such as Spin-Torque-Transfer RAM (STT-RAM), Phase Change RAM (PCM), Resistive RAM (ReRAM), etc. Further, system 100 includes a persistent data store 150. The persistent data store 150 shares the same physical memory as the shadow index 120. Operating on the second index 120 and within the persistent memory 140 is a shadow thread 170. The shadow thread 170 is a process that updates the shadow index 120 based on information contained only within the persistent data store 150 and outside of the first index 110 within the volatile memory 130.

When data (records/entries/documents, hereinafter “documents”) are written to the persistent data store 150, the first index 110 in is updated, which is a fast operation. The second index 120 is updated continuously in the background without impacting the user access data path. In one embodiment, the persistent data store 150 is arranged in a log structure architecture such that the records will be added in the order of arrival. This allows for the update of the second index 120 in a lazy manner by scanning the actual records in persistent data store 150. The records that were processed by the shadow thread will be marked as processed in the shadow index 120. During the recovery process following a failure, all the records that weren't processed by the shadow thread at the time of the failure will be added to the shadow index 120. With the approach of the present disclosure, a history of the changes is maintained with the data as opposed to in a separate log thus allowing for a single write of the data to the persistent memory.

System 100 provides advantages in, for example, a byte addressable fast memory, as the indexes are updated in the persistent data. In hard disks or solid state devices which use page granularity, it is inefficient to update the indexes in the background at a page granularity. In the present system a record is written only once to the persistent memory. This record is used both as the data and as a log to the index. The present system can balance the trade-off between update frequency of the shadow index and recovery time. With fast update of the shadow index, it is possible to achieve a fast recovery time. This provides an upper bound of the recovery time, however, it can harm the performance of the main path. A slow update of the shadow index would require a longer recovery time, but with better performance on the main path. As such the present disclosure permits the balancing of these two features

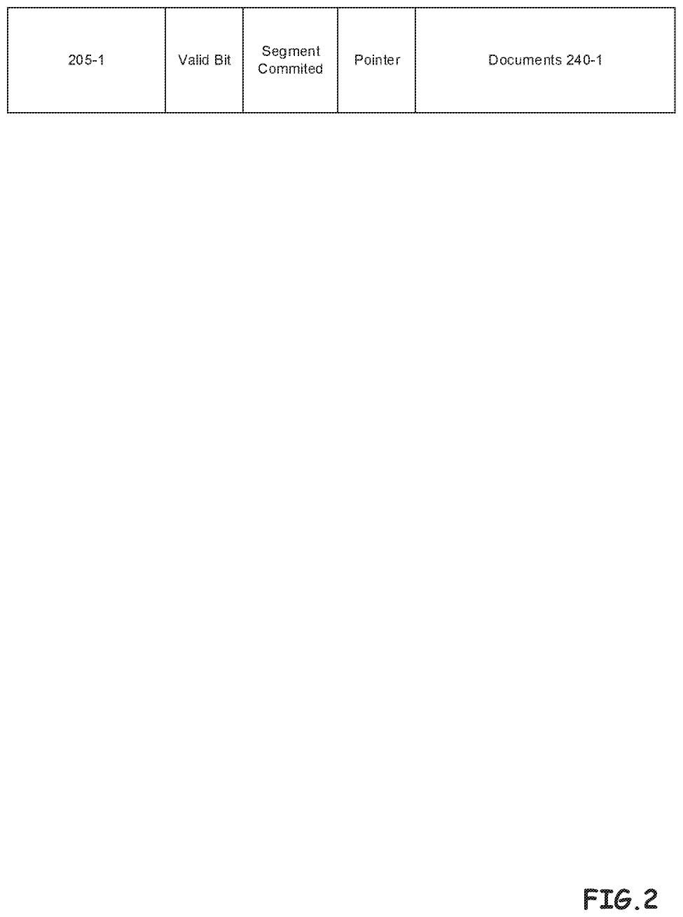

An example of the implementation of the present disclosure is provided with respect to FIGS. 2-5. This example is based on a NoSQL database with a log structure architecture. While the example given is NoSQL, it should be recognized that the present disclosure is applicable on any number of database approaches. For purposes of this discussion, database is a document-oriented database. Again, the database can store any type of data in the corresponding records. The data stored in the database are separated into documents (records) that are to be stored in the persistent memory. Documents are the smallest elements that can be inserted or deleted in the database. Each document contains a set of fields that can be updated. Further, each document is referenced by a unique primary key.

FIG. 2 is a diagrammatic illustration illustrating a relationship between segments in the persistent memory according to embodiments. The persistent memory is divided into a number of segments 201-1, 201-2, 201-N (collectively 201). A segment is a persistent block of memory of a fixed size. Each segment includes one or more documents 240-1, 240-2, 240-N (collectively 240). A segment also has a header 205-1, 205-2, 205-N (collectively 205), valid bits 210-1, 210-2, 210-N, 220-1, 220-2, 220-N (collectively 210 and 220), and a pointer 230-1, 230-2, 230-N (collectively 230) to the next segment. The header allows for the ability to recognize each particular segment. In some embodiments the header may be referred to as a magic number. The first valid bit 210 indicates whether the particular segment is valid. This bit is set when the segment is first created. The second valid bit 220 indicates that the shadow thread has processed the associated segment and all of the associated documents in the segment have been committed. The pointer 230 points to the next segment in a series of segments. This allows for the series of segments to form a linked list of segments.

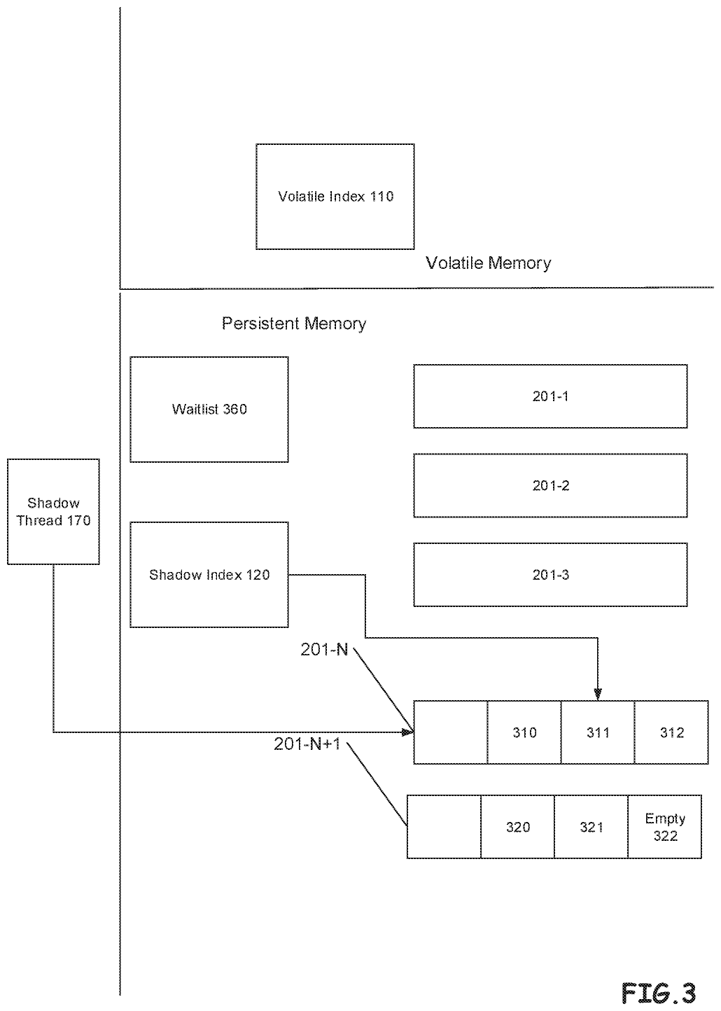

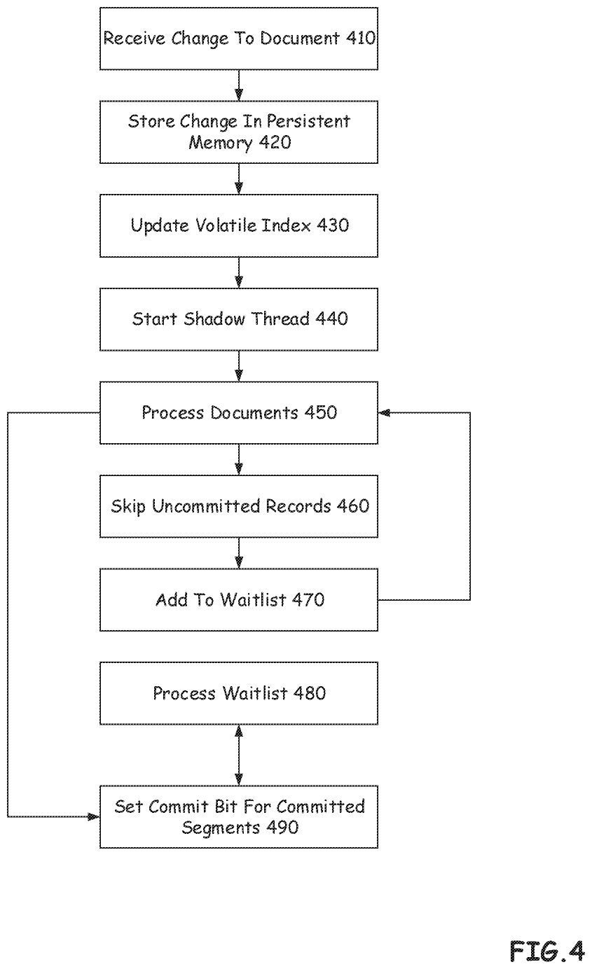

FIG. 3 is a diagrammatic illustration illustrating a relationship between segments in the persistent data store 150 when documents are being processed by the shadow thread 170 according to embodiments. FIG. 4 is a flow diagram illustrating a process for updating the shadow index 120 by the shadow thread 170 according to embodiments. As discussed above there are two indexes 110, 120 in system 100. These two indexes 110, 120 are copies of each other. One copy is in the volatile memory and is referred to as the volatile index 110. The terms first index and volatile index 110 are used interchangeably herein. The second copy is in the persistent data store 150 and is referred to as the shadow index 120. The terms second index and shadow index 120 are used interchangeably herein. During a change command within the database (e.g. insert, delete, update, etc.) the volatile index 110 is updated immediately upon execution of the change command. The change to the document is illustrated at step 410.

The changed document is then stored in the persistent data store 150. This is illustrated at step 420. The document can be inserted, updated, or deleted. When the document is inserted it is inserted in the persistent data store 150 in the next segment 201 that has enough free space to store the document. When a document is updated in the database, it can be updated in one of two ways. The first is an update in place, and the second is update by inserting in a new location. When a document is deleted in the database, the system inserts a small document into the segments. This small document (tombstone) shares the same primary key as the document that is to be deleted, and also contains an indication that document is a special document. The update of the volatile index 110 is illustrated at step 430.

The shadow thread 170 is executed in the background to update the shadow index 120. However, in some embodiments the shadow thread is executed at a different time. The starting of the shadow thread 170, and generation of the shadow index 120 if necessary, is illustrated at step 440. The shadow thread 170 maintains a volatile pointer that points to the next document that will be processed by the shadow thread 170. Illustrated, by line 350 pointing to document 311 in segment 201-N. The shadow thread also maintains a persistent pointer that points to the first segment 201 from which the recovery process should start from. (e.g. segment 201-N). These pointers are provided to reduce the recovery time in the event of a crash or other failure, and to eliminate the need to start the recovery process from the beginning of the shadow index 120.

The shadow thread 170 processes the documents in the order that the appear in persistent data store 150 and updates the shadow index 120 as appropriate. This is illustrated at step 450. FIG. 3 illustrates segments 201-1, 201-2, 201-3, 201-N, and 201-N+1. Only documents within segments 201-N and 201-N+1 are illustrated separately. These documents are documents 310, 311, 312, 320, and 321 representing existing documents. Document 322 represents the next empty space in segment 201-N+1. It should be noted that any segment 201 can include documents or empty space. For example, the segments are linked listed to each other, and the next empty space can be just at the last segment. The document is then inserted in the persistent data store 150 in the next segment 201 that has enough free space to store the document. When a document is inserted into the database, the volatile index 110 is updated in the critical path. Meanwhile, the shadow thread 170 continues to process the documents in the persistent data store 150 in the background. As such, the shadow thread 170 does not reach the newly inserted document until such time as the document is encountered through the ordered progression through all of the segments. When the shadow thread 170 arrives at the newly inserted document, it does not have the knowledge of whether the document is a new document or an updated document. To determine whether the document is new or updated, the shadow thread 170 searches the shadow index 120 for a primary key that matches the primary key for the document. If the primary key is found, the shadow thread 170 treats the document as an updated document (discussed later). If the primary key is not found in the shadow index 120, the shadow thread 170 inserts primary key in the shadow index 120 at this time.

When a document is updated in the database, it can be updated in one of two ways. The first is an update in place, and the second is update by inserting in a new location. In the first case the document update can be executed in place. That is the changes to the document can be executed through an atomic write, such as 3DXpoint on an X86 processor in a cache line. In this instance when the shadow thread 170 comes upon the document in the segment 201 and finds the corresponding entry in the shadow index 120. As a result, the shadow thread 170 does nothing to the entry in any of the indexes. However, if the update cannot, for whatever reason, be updated in place, the system will create a new document represent the updated version of the document. This document is inserted into the next segment 201 that has space available for the updated document. At this time the volatile index 110 is updated to point to the inserted document. When the shadow thread 170 reaches this document in the segments, the thread does not have the knowledge of whether the document is a new document or an updated document. To determine whether the document is new or updated, the shadow thread 170 searches the shadow index 120 for a primary key that matches the primary key for the document. Again, if the primary key is not found in the shadow index 120, the shadow thread 170 inserts primary key in the shadow index 120 at this time. If the primary key is found, the shadow thread 170 updates the shadow index 120 to now point to the location of the updated document. The shadow thread 170 then inserts a pointer for the old version of the document to point to an invalid list or otherwise indicate that this version of the document is no longer valid. This permits the document to be cleaned during a garbage collection process.

When a document is deleted in the database, the volatile index 110 is updated to remove the document reference from the volatile index 110. At the same time the system inserts a small document into the segments. This small document shares the same primary key as the document that is to be deleted, and also contains an indication that document is a special document. This indication indicates that the document is to be deleted or is otherwise a tombstone document. When the shadow thread 170 comes to this special document, the thread searches the shadow index 120 for the pointer associated with the special document. As this pointer is found in the shadow index 120, the shadow thread 170 removes the deleted key from the shadow index 120, adds two volatile pointers associated with both the original version of the document in the shadow index 120 and for the special document to point to the list of documents that are no longer valid. However, in some embodiments the pointer can be an indication that the document is no longer valid. Once these pointers have been set these documents can be removed during a garbage collection process.

If the shadow thread 170 is processing a document that has not yet been committed by the system, the document is skipped. This is illustrated at step 460. At this time a pointer to the skipped document is placed in a volatile list referred to as a waitlist 360. This is illustrated at step 470. After the shadow thread 170 finishes a processing a document it continues through the remaining documents in that are in the persistent data store 150. Again, these documents are processed in the order in which they appear in the persistent data store 150.

Once the shadow thread 170 completes the processing of the documents in the persistent data store 150, it returns to the waitlist 360 to process those documents that were previously not committed when the shadow thread 170 came to those documents. This is illustrated at step 480. The shadow thread 170, again processes the documents in the waitlist 360 in the order which they appear in the waitlist 360. If the particular document still has not been committed at this time, it is skipped by the shadow thread 170. If the document has been committed the shadow index 120 is updated to include the document, and the document is removed from the waitlist 360. The shadow thread 170 continues to process each document in the waitlist 360 until it reaches the end. If there are still documents in the waitlist 360, the shadow thread 170 returns to the beginning of the waitlist 360 and continues through the waitlist 360 again. In some embodiments, the shadow thread 170 returns to processing documents in the persistent data store 150 before returning back to process entries in the waitlist 360.

The shadow thread 170 is configured to set the configured bit for a segment 201 when all of the documents in the particular segment 201 are in a committed state. This is illustrated at step 490. It should be noted that step 490 can occur at any point in the process the shadow thread 170 determines that all of the documents in the particular segment 201 have been committed. The committed bit remains unset until all of the documents in a particular segment 201 are committed. Thus, the documents in a particular segment 201 must not exist in the waitlist 360 for the commit bit to be set. Once the committed bit is set, a garbage collection process can be performed on that particular segment 201. If the bit is not set, then the segment 201 is precluded from the garbage collection process.

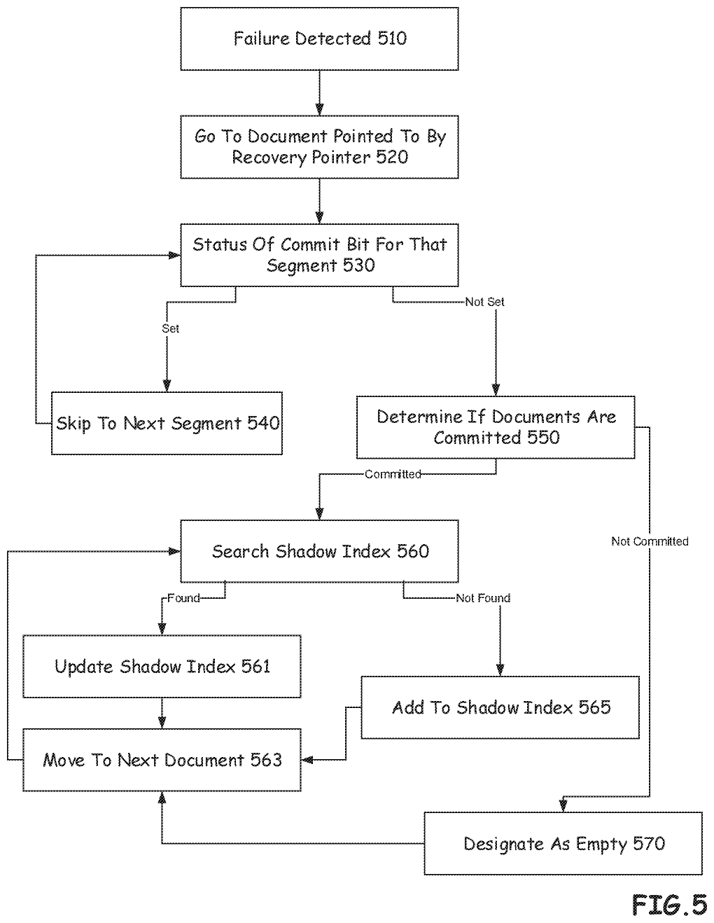

FIG. 5 is a flow diagram illustrating a process for recovering the database according to embodiments. The shadow thread 170 continues to process documents as discussed above with respect to FIG. 4 until such time as a recovery process needs to be executed. The recovery process begins after, for example, a crash or other failure of the database or the underlying physical systems. The failure is illustrated at step 510. The recovery process iterates over the segments in the order that the segments appear in the persistent data store 150. The recovery process cleans uncommitted documents and adds missing indexes to the shadow index 120. The recovery thread begins from the segment 201 that is pointed to by the persistent pointer. This is illustrated at step 520. Again, this pointer points to the first segment that was not fully processed by the shadow thread 170 prior to the failure. The recovery thread checks to the status of the commit bit for this segment 201. This is illustrated at step 530.

If the commit bit for this particular segment is set, the recovery thread skips this segment 201, and moves on to the next segment 201 in the persistent data store 150. This is illustrated at step 540. This segment 201 is skipped because all of the documents in the segment 201 were committed and existed in a persistent state prior to the failure, and thus, the index for each of the documents already exists in the shadow index 120.

If the commit bit is not set the recovery thread analyzes each of the documents in this segment 201 to determine if each of the documents is already committed. This is illustrated at step 550. If a document in the segment 201 is committed, the recovery thread will search the shadow index 120 to determine if the document's key already exists in the shadow index 120. This is illustrated at step 560. The search of the shadow index 120 is done using the primary key for the document. If the document is found during the search, the process updates the shadow index to point to the new document instead of the old document. The old document is considered as empty. This is illustrated at step 561. then the recovery process moves to the next document in the segment 201. This is illustrated at step 563. However, if the existing document is a delete document or tombstone, the process removes the pointer from the shadow index, and are considered as empty documents. If the document does not exist in the shadow index 120, the recovery thread will add the document to the shadow index 120. This is illustrated at step 565. Again, this is done by inserting the primary key of the document into the shadow index 120. Once the document is added to the shadow index 120 the recovery process proceeds to step 563 and moves to the next document in the segment 201. If the document has not been committed, or in the case where the document is an uncommitted tombstone document, the recovery thread designates the particular document as an empty document. This is illustrated at step 570. This permits the garbage collection process to clean the particular segment 201. After this designation as an empty document, the recovery process proceeds to step 563 and moves to the next document in the segment 201.

In some embodiments to permit a faster recovery the system can begin working using the shadow index 120 as the primary index. In this embodiment, the shadow index 120 is duplicated to a new primary index in the volatile memory. This is illustrated as step 515. In some embodiments, this duplication is performed as a background operation. New change operations to the database (e.g. insert, remove, etc.) are inserted only into to the new primary index in the volatile memory. In this embodiment, during the index search process of the recovery process, the recovery thread searches both the shadow index 120 and the new primary index for an entry corresponding to the committed document. However, in some embodiments, the system waits until after the shadow index 120 has been fully duplicated into the volatile memory as a new primary index before permitting the overall system to restarted.

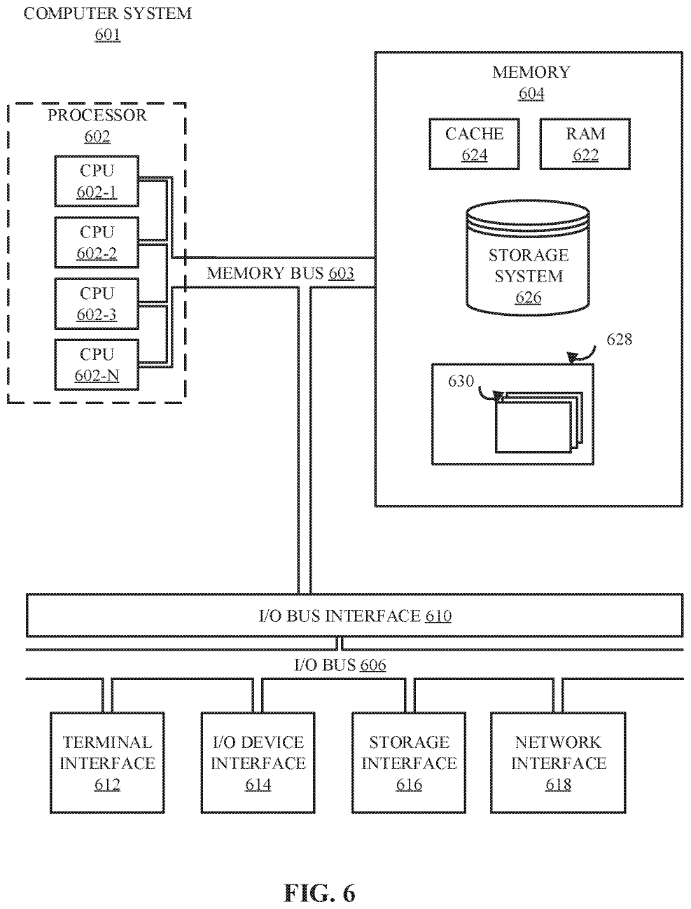

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602-1, 602-2, 6023, 602-N, herein collectively referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

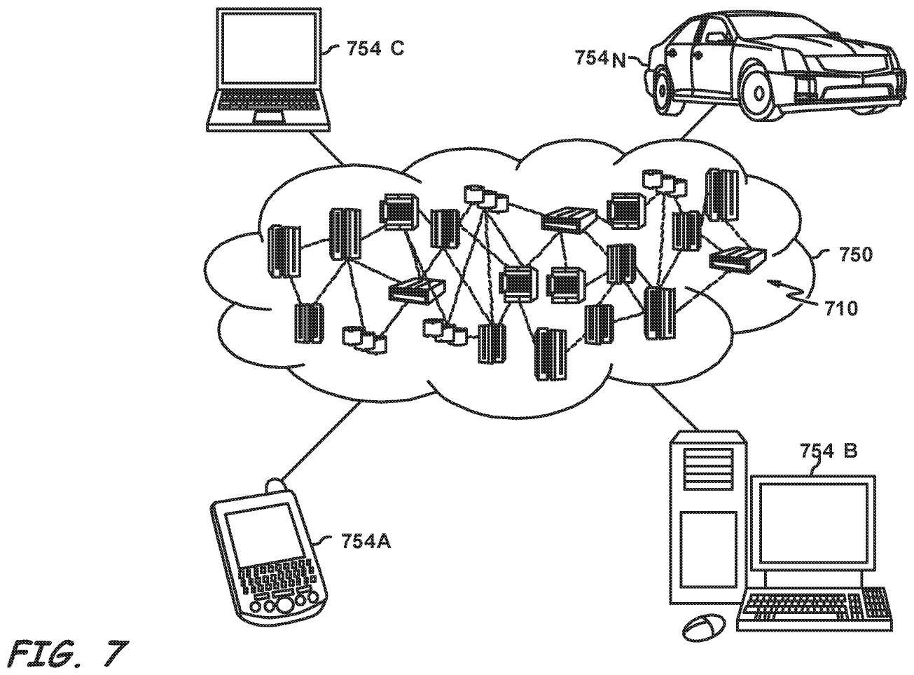

The system 50 may be employed in a cloud computing environment. FIG. 7, is a diagrammatic representation of an illustrative cloud computing environment 750 according to one embodiment. As shown, cloud computing environment 750 comprises one or more cloud computing nodes 95 with which local computing devices used by cloud consumers, such as, for example, personal digital assistant (PDA) or cellular telephone 754A, desktop computer 754B, laptop computer 754C, and/or automobile computer system 754N may communicate. Nodes 95 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 5 and cloud computing environment 750 may communicate with any type of computerized device over any type of network and/or network addressable connection (e.g., using a web browser).

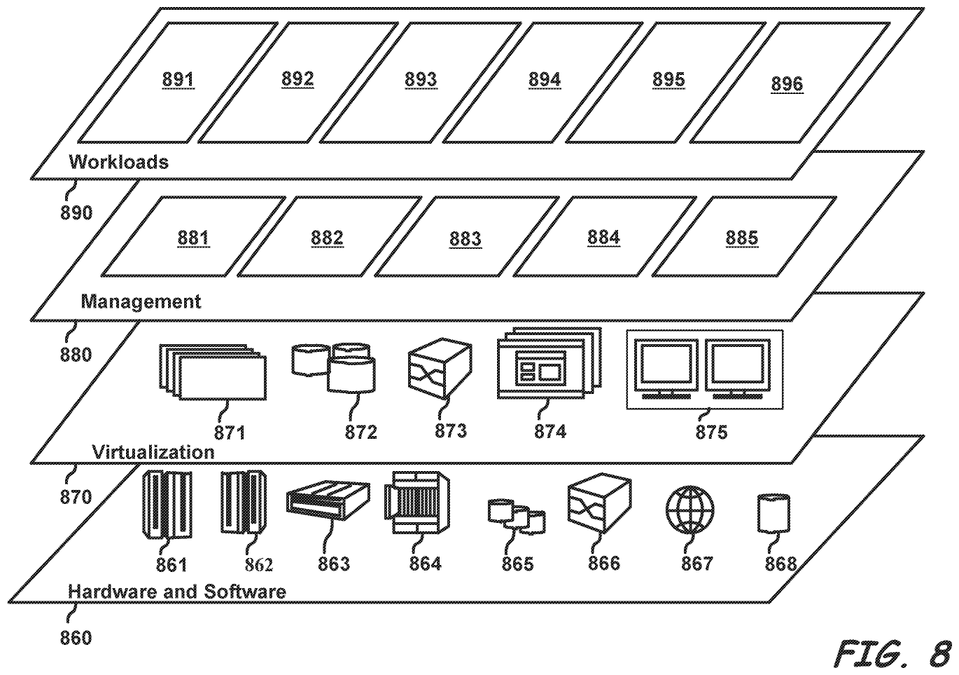

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the disclosure are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; layout detection 893; data analytics processing 894; transaction processing 895; and database 896.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for recovering a database and restoring an index following a failure of the database comprising:
receiving a change to a document in a database, the database having a plurality of documents;
storing the change to the document in the database in a persistent data store, the persistent data store divided into a plurality of segments;
updating a volatile index in volatile memory with a pointer to the document in the persistent data store;
generating a shadow index in the persistent data store, wherein the shadow index is a persistent copy of the volatile index, and is not updated at the same time as the volatile index; and
executing a shadow thread on the plurality of documents wherein the shadow thread scans each record in the persistent storage device to populate and update the shadow index, wherein the shadow thread operates as a background operation on the persistent data store.

2. The method of claim 1 wherein the change is inserting the document.

3. The method of claim 1 wherein the change is deleting the document.

4. The method of claim 1 wherein the change is updating the document.

5. The method of claim 1 wherein updating the document, further comprises:
inserting the document as a new document in the database, wherein the new document includes a primary key that is identical to a primary key associated with a prior version of the new document;
searching by the shadow thread the shadow index for a primary key;
if the primary key is found in the shadow index, updating the shadow index to point to the new document; and
inserting a pointer for the prior version, the pointer for the prior version pointing to an invalid list.

6. The method of claim 1 further comprising:
inserting a restart pointer in the shadow index, the restart pointer pointing to the first segment that was not fully processed by the shadow thread.

7. The method of claim 6 further comprising:
updating the restart pointer in response to processing a last document in the segment by the shadow thread to point to a next segment.

8. The method of claim 1 wherein each segment of the plurality of segments includes a header, the header comprising a segment commit bit, the segment commit bit indicating whether all documents in the associated segment have been committed.

9. The method of claim 1 further comprising:
checking, by the shadow thread, for a segment, each document in the segment to determine if each document in the segment has been committed; and
setting by the shadow thread the commit bit to a committed state when all of the documents in the associated segment have been committed.

10. The method of claim 1 wherein when the shadow thread encounters a segment that includes at least one document that has not been committed, further comprising:
skipping adding the at least one document that has not been committed to the shadow index; and
adding a pointer to the at least one document that has not been committed to a waitlist.

11. The method of claim 1 further comprising:
detecting a failure of the database;
executing a recovery thread; and
duplicating the shadow index to the volatile memory as the volatile index.

12. A system for recovering a database and restoring an index following a failure of the database, comprising:
a processor;
a memory device;
a database, having a plurality of records; and
wherein the processor is configured to perform the steps of:
receiving a change to a record in the database;
storing the change to the record in the database in a persistent data store, the persistent data store divided into a plurality of segments;
updating a volatile index in volatile memory with a pointer to the record in the persistent data store;
generating a shadow index in the persistent data store, wherein the shadow index is a persistent copy of the volatile index, and is not updated at the same time as the volatile index; and
executing a shadow thread on the plurality of records wherein the shadow thread scans each record in the persistent storage device to populate and update the shadow index, wherein the shadow thread operates as a background operation on the persistent data store.

13. The system of claim 12 wherein the change is inserting the record.

14. The system of claim 12 wherein the change is deleting the record.

15. The system of claim 12 wherein the change is updating the record.

16. The system of claim 15 wherein updating the record, further comprises:
inserting the record as a new record in the database, wherein the new record includes a primary key that is identical to a primary key associated with a prior version of the new record;
searching by the shadow thread the shadow index for a primary key;
if the primary key is found in the shadow index, updating the shadow index to point to the new record; and
inserting a pointer for the prior version, the pointer for the prior version pointing to an invalid list.

17. The system of claim 12 further comprising:
inserting a restart pointer in the shadow index, the restart pointer pointing to the first segment that was not fully processed by the shadow thread; and
updating the restart pointer in response to processing a all records in a segment by the shadow thread pointed to by the restart pointer.

18. The system of claim 12 further comprising:
checking, by the shadow thread, for a segment, each record in the segment to determine if each record in the segment has been committed; and
setting by the shadow thread the commit bit to a committed state when all of the records in the associated segment have been committed.

19. A computer program product, having computer executable instructions that when executed by one or more processors, causes the one or more processors to:
receive a change to a record in a database, the database having a plurality of records;
store the change to the record in the database in a persistent data store, the persistent data store divided into a plurality of segments;
update a volatile index in volatile memory with a pointer to the record in the persistent data store;
generate a shadow index in the persistent data store, wherein the shadow index is a persistent copy of the volatile index, and is not updated at the same time as the volatile index;
execute a shadow thread on the plurality of records wherein the shadow thread scans each record in the persistent storage device to populate and update the shadow index, wherein the shadow thread operates as a background operation on the persistent data store;
when the shadow thread encounters a segment that includes at least one record that has not been committed, further comprising instructions to:
skip adding the at least one record that has not been committed to the shadow index; and
add a pointer to the at least one record that has not been committed to a waitlist.

20. The computer program product of claim 19 further comprising instructions to:
detect a failure of the database;
execute a recovery thread; and
duplicate the shadow index to the volatile memory as the volatile index.
